(19) United States
(12) Patent Application Publication
(10) Pub. No.: US 2006/0141426 A1
(43) Pub. Date: Jun. 29, 2006

(54) Virtual scene interactive language learning system and method

(75) Inventors: Zechary Chang, Taipei (TW); Pinky Ma, Beijing (CN); Manfred Kuo, Beijing (CN)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/019,357

(22) Filed: Dec. 23, 2004

(51) Int. Cl. G09B 19/04

(52) U.S. Cl. 434/185

(57) ABSTRACT

A virtual scene interactive language learning system and method adopts a server/user end architecture to simulate a real language environment to enable users to learn language in selected scenes. Current scene conditions are confirmed by data exchange between the user end and the server end. A cycle editing is performed for scene elements according to the scene conditions. The edited interfaces are presented to the user end. Voice data input at the user end are received to make corresponding responses at the user end so that users can learn the language deftly.

### FIELD OF THE INVENTION

The present invention relates to a language learning system and method, and particularly to a virtual scene interactive language learning system and method.

### BACKGROUND OF THE INVENTION

Language is a key to unravel the secret of a new culture. With the international exchange-taking place more frequently, learning a language has become one of the essential conditions of success in life.

Learning a language aims to use the language more fluently. The conventional language learning methods mostly adopt classroom instruction. However, many studies indicate that good students mostly are not developed by “teaching” by instructors in the classroom, but are developed by “guiding” by the instructors in the classroom and outside the classroom. In terms of language learning, it is not advisable to totally rely on classroom instruction, self-study and practice also are very important. In other words, it is essential to establish a language environment to enable students to learn English in life. As life covers a wide range of aspects, the English learning environment also may be expanded tremendously. To learn English well, the students have to understand the language and all sorts of cultural information conveyed by the language.

In order to establish a better language environment, some improved teaching methods have been developed, such as totally closed English learning and participating English exchange activities, etc. However, those methods have time and space constraints. They also do not offer much breakthrough and innovation in the instruction concepts, instruction contents and teaching methods.

The most effective language learning method is to move the students to the place where the language originates. But this is not possible for most people. The purpose of learning English is to use it well. Hence if the students can create by themselves a virtual language environment to combine the instructions and practices, it is more effective and enables the students to use the language more deftly.

### SUMMARY OF THE INVENTION

Therefore the present invention aims to resolve the aforesaid disadvantages and provide a virtual scene interactive language learning system and method that employs network technologies and combines instructions and practices and establish a real-like language environment to improve language learning efficiency and increase fun and interest.

In order to achieve the foregoing objects, the present invention provides a virtual scene interactive language learning system that adopts server/user end architecture to simulate a real language environment to enable users to learn language in selected scenes. The system includes a scene database to store a plurality of scenes corresponding to selected subjects and scene elements corresponding to the scenes, a logon module to monitor linking signals sent by the user end and authenticate their legitimacy, and set up the user in the server based on the legitimacy, a schedule management module to manage the schedule of the user end and confirm the current condition of the scene through data exchange between the user end and the server end, a scene editing module to perform cycle editing for the scene elements corresponding to the scene condition, and present the edited interface to the user end and receive action operation input from the user end and make corresponding responses based on the action operation, a language exchange module to receive voice data input from the user end and make corresponding responses at the user end based on the voice data, and a logoff module to receive logoff information from the user end and remove the user from the server based on the logoff information and store attribute data of the user in the server.

The invention further provides a virtual scene interactive language learning system and method that adopts server/user end architecture to simulate a real language environment to enable users to learn a language in selected scenes. First, store a plurality of scenes corresponding to selected subjects and scene elements corresponding to the scenes; next, monitor linking signals sent by the user end and authenticate their legitimacy, and set up the user in the server based on the legitimacy; manage the schedule of the user end and establish instant communication between the user end and the server end, and confirm the current condition of the scene through data exchange between the user end and the server end; perform cycle editing for the scene elements corresponding to the scene condition, and present the edited interface to the user end and receive action operation input from the user end and make corresponding responses based on the action operation; receive voice data input from the user end and make corresponding responses at the user end based on the voice data; finally receive logoff information from the user end and remove the user from the server based on the logoff information and store attribute data of the user in the server.

The invention exploits the advantages of network media in the network environment and is designed to focus student's self-learning activities. It provides a quality learning support services and fosters a desired English learning atmosphere. It enables the students to fully develop the self-consciousness, self-initiative and creativity of language learning. It employs the existing technologies to create a virtual community to enhance the focus of language learning, and is expandable and flexible. The content of the subject communities may be adjusted as desired according to the language learning progress. New communities may also be established to target new language learning hot spots.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of module architecture of the virtual scene interactive language learning system of the invention;

FIG. 2 is a schematic view of module architecture of an embodiment of the invention;

FIG. 3 is an operation flow chart of the virtual scene interactive language learning method of the invention;

FIG. 4 is a schematic view of a logon interface of the invention;

FIG. 5 is a schematic view of a selected subject community interface of the invention;

FIG. 6 is a flow chart of a human machine dialog of the invention;

FIG. 7 is a schematic view of a human machine dialog interface of the invention;

FIG. 8 is a schematic view of an individual instruction interface of the invention;

FIG. 9 is a flow chart of a human machine dialog of the invention; and

FIG. 10 is a schematic view of a classroom instruction interface of the invention.

### DESCRIPTION OF THE PREFERRED EMBODIMENTS

The present invention aims to employ the existing technologies to create a virtual community where there are virtual people who have people's mind and relationship, and conflicts and harmony between people and nature and the society. Like a network community, the invention may also set up communities of different subjects such as “New York Street”, “London Street” and the like. Each subject community has a unique social atmosphere and human environment. The main characteristic of the virtual community is “virtual”. It not only has hardware facilities of a virtual city, a more important aspect is that it also has a simulated virtual human environment. For example the language used by NPC (a virtual person) localized in the community, the building styles are realistic, etc. to enable users to sense as much cultural atmosphere as possible.

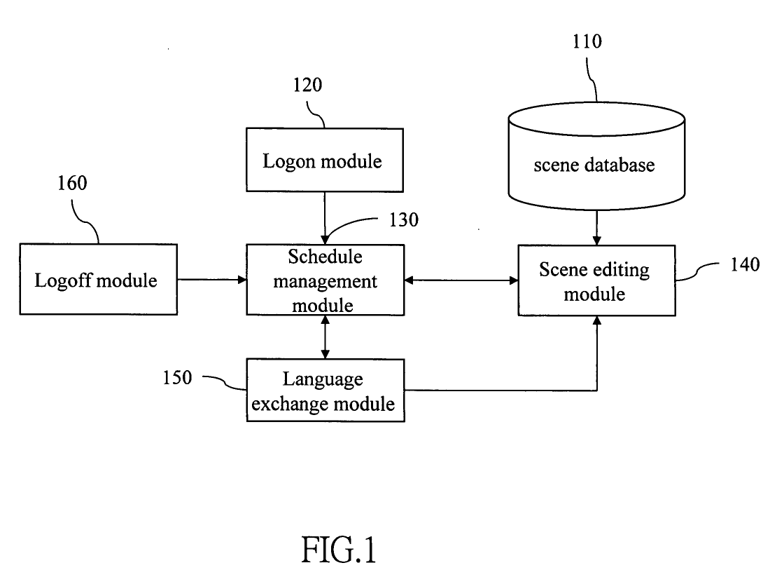

Refer to FIG. 1 for module architecture of the virtual scene interactive language learning system of the invention. It employs server/user end architecture to simulate a real language environment to provide users to learn language in selected scenes. It includes a scene database 110, a logon module 120, a schedule management module 130, a scene editing module 140, a language exchange module 150, and a logoff module 160. More details of the module architecture are elaborated as follow:

1. The scene database 110 stores a plurality of scenes corresponding to selected subjects and scene elements corresponding to the scenes. The scene elements include background elements, object elements, people elements and sound elements.

2. The logon module 120 aims to monitor linking signals sent by users at the user end and authenticate their legitimacy, and set up the users in the server based on the legitimacy.

3. The schedule management module 130 manages the schedule of the user end and confirms the current condition of the scene through data exchange of the user end and the server end.

4. The scene editing module 140 performs cycle editing for the scene elements corresponding to the scene condition, and presents the edited interface to the user end and receives action operation input from the user end and makes corresponding responses based on the action operation.

5. The language exchange module 150 receives voice data input from the user end and makes corresponding responses at the user end based on the voice data.

6. The logoff module 160 receives logoff information from the user end and removes the user from the server based on the logoff information and stores attribute data of the user in the server. The attribute data include physical value, charismatic value, a moral index and a health index.

The system set forth above may include an attribute calculation module 170 linking to the scene-editing module to calculate user attribute data according to the responses and store the attribute data in the server end.

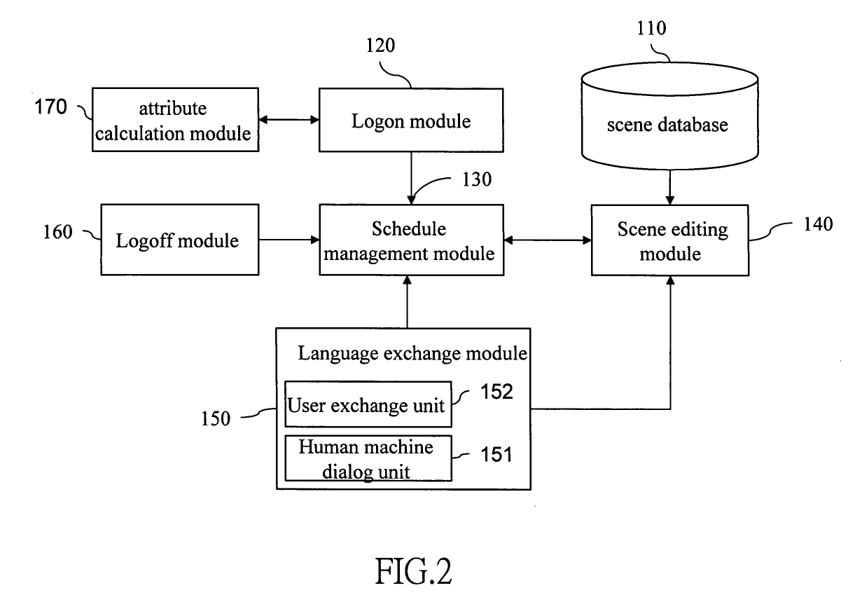

Referring to FIG. 2, the language exchange module 150 further includes a human machine dialog unit 151 and a user exchange unit 152. The human machine dialog unit 151 receives the voice data input by a user and compares the voice data with a sentence model in the server. It also may receive contents entered by the user through a keyboard and compare the contents with the sentence model, and retrieve a corresponding answering sentence according to the comparing result and send the retrieved answering sentence to the user end for displaying, thereby implementing audio human machine dialogs or text exchange between person and machine. The user exchange unit 152 aims to implement communication exchange of online users. It may be an instruction unit, which includes class instructions and individual instructions. The users at the user end may be classified as instructor users and student users. A connection may be established between an online instructor user and a plurality of online student users, and the information input by the online instructor user may be instantly sent to the student end for displaying.

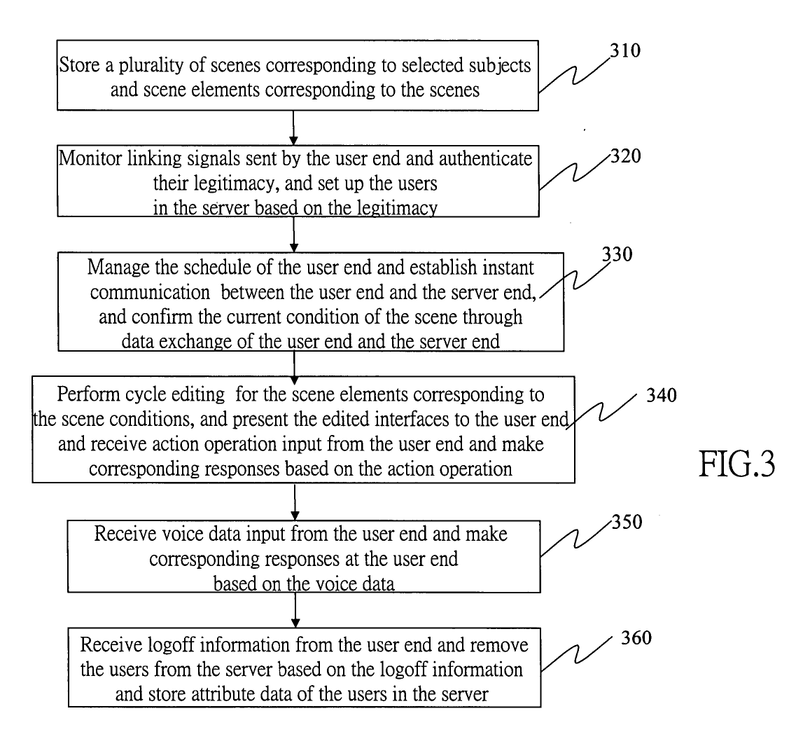

Refer to FIG. 3 for the process flow of the method of the invention. It adopts server/user end architecture to simulate a real language environment to enable users to learn language in selected scenes. First, store a plurality of scenes corresponding to selected subjects and scene elements corresponding to the scenes (step 310); next, monitor linking signals sent by the user end and authenticate their legitimacy, and set up the users in the server based on the legitimacy (step 320); manage the schedule of the user end and establish instant communication between the user end and the server end, and confirm the current condition of the scene through data exchange between the user end and the server end (step 330); perform cycle editing for the scene elements corresponding to the scene condition, and present the edited interface to the user end and receive action operation input from the user end and make corresponding responses based on the action operation (step 340); receive voice data input from the user end and make corresponding responses at the user end based on the voice data (step 350); finally receive logoff information from the user end and remove the user from the server based on the logoff information and store attribute data of the user in the server (360).

More details of the invention are discussed below by learning English as an example.

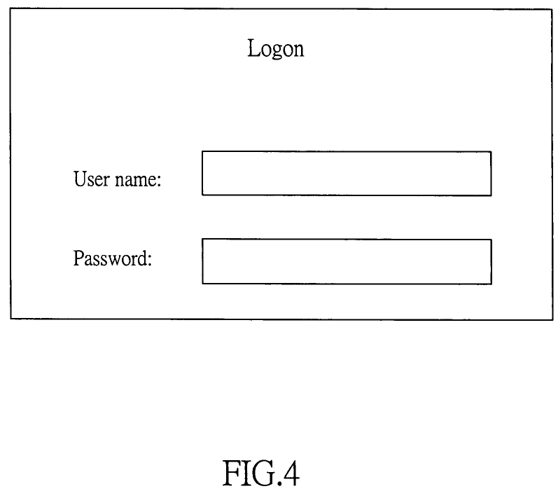

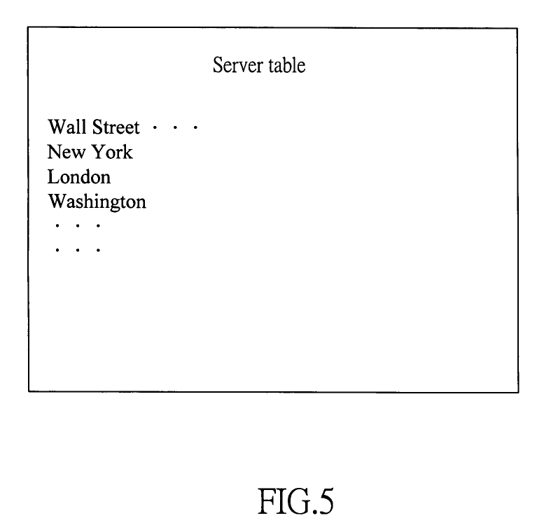

Referring to FIG. 4, first, a user end downloads a virtual community hall. After program execution, a user logon interface is displayed to request the user to enter user name and password. For a new user, he/she must register first. User registration may be classified according to a different language level, such as an instructor user and a student user. The system-initialized data include the user name and password input by the user. Then connection between the user end and the server is established, and the user name and password are sent to the server for authentication. After the authentication has been confirmed and accepted by the server, enter a server table interface as shown in FIG. 5. User can select a desired subject community. Each subject community is designed according to the local language and human environment. After the user has selected the desired community, for the first time user registering to that community, the system highlights to set up the user's profile, such as sex, age, hair color, etc. Once set up, the user can enter the virtual community. Upon entering the community, a 3D user interface is presented to the user to enable the user to experience the real life and physiological feeling in the virtual space interface. All buildings in the community are distributed on a map of a selected size. Each unit spot on the map corresponds to a unique coordinate. Meanwhile, the interior of each building in the community also is a map. Passing through the “door” of a building, transport may be carried out among the maps. The system instantly confirms the current scene condition through data exchange between the user end and the server end. The scene may have many choices, such as shopping scene, sport scene and asking direction scene, and the like. The system performs cycle editing of the scene elements according to the scene condition. The edited interface is presented on the user end. All new users have to be generated in the hall of a “community service center”.

A new user has to report to the reception counter first to receive the basic education of the community rules (including the speaking manner to NPC, etc.). After having passed the basic test, the user gets a community resident ID and some currency to become a formal community resident. The hall at the community service center is the only place in the entire community where exchange by mother language is permitted. By showing the “community ID” to the guard at the door of the hall, the user can go in or out of the hall freely. The server end instantly receives action operation input from the user end, and confirms the current condition through the exchange information between the user end and the server, and performs corresponding responses according to the action operation, such as altering location of people, dropping of objects, etc.

If the user finds out that his/her language cannot be accepted by NPC or cannot exchange normally with other people in a certain scene in the community, the user can submit a training request at the “reception counter” of the “hall of the community service center”. The “community government” (namely, the community administrator) will arrange regular training courses related to the subject according to the requirements of the general public (the courses are classroom instructions for multiple students, and are free of charge). Course schedules are posted on a bulletin board beside the “reception counter”. To users who cannot attend the courses, they can purchase the “course recording” in the community “video shop” to play on the TV in their “home” (this service is difficult for the new user to enjoy. It is a benefit granted after the user has devoted some efforts). The instruction is conducted flexibly. “Classroom instruction” is only the most common approach. The user may also request to have face-to-face interactive instruction with the instructor. Such an arrangement is charged. The subjects of the courses could increase continuously with the development of the community. In addition, professional instructors may appear in the community as an ordinary resident to offer guidance to the public.

The aforesaid embodiment mainly aims to learning English through conversation, hence the server end receives voice input from the user end and makes response at the user end according to the voice information. Conversation in the community may be performed in many ways, such as a human-machine dialog, private chat, public speaking and group discussion. The private chat is a one to one conversation. The public speaking is one- to- many talk (such as teaching done by an instructor), group discussion is conversation among many users.

Living in the community has to obtain all sorts of information. The information has many sources. At the primary level, the main source is from the conversation with NPC. The NPC can provide many important services and information to the users in the community. The users can also buy living staples at the shop run by NPC.

As NPC can understand only a selected language, to do a normal exchange with NPC has to be learned in the “community service center”. There are many professional foreign language instructors in the service center. They know every detail of the community and can precisely express themselves. And they conduct various online instructions according to user requirements, such as regular classroom instructions for contents that have a lot of questions, or solve individual problems in an acceptable way.

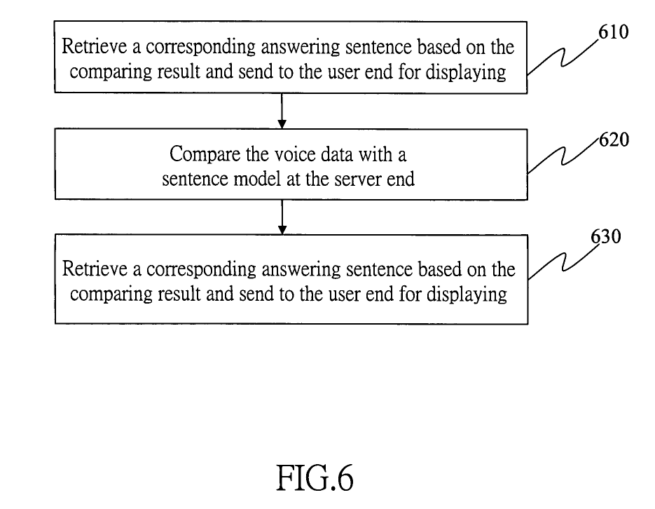

Refer to FIG. 6 for the process flow of a human-machine dialog according to the invention. First, receive voice data input by a user (step 610); next, the voice data are compared with a sentence model at the server end (step 620); based on the comparing result, a corresponding answering sentence is retrieved and sent to the user end for displaying (step 630).

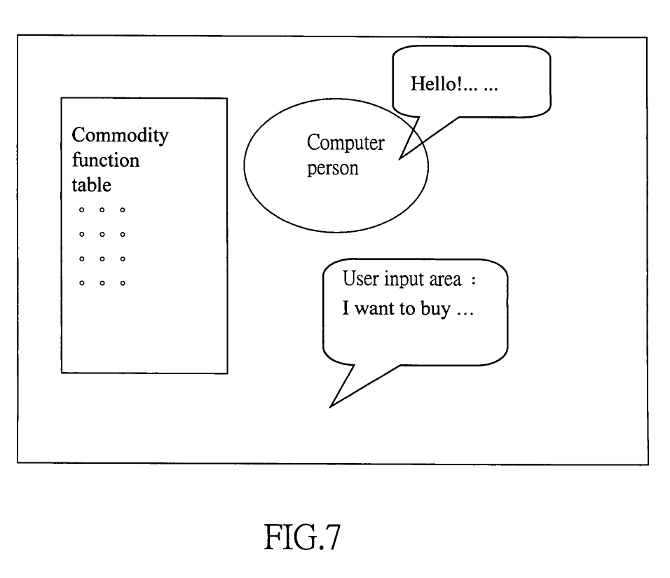

Refer to FIG. 7 for a human machine interface. It is a shopping scene. In the community every person has his/her own voice database. The voice database mainly is divided into a “standard receiving database” and a “standard answer database”. The former one is a cluster input by the user, understandable by the computer people. The latter is a cluster of answering sentences made by the computer people to the user. The “standard receiving database” further includes a “sentence model database” and a “keyword database”. The user end receives inputs of the user, and retrieves keywords from the user's input, then compares the rest portion with the data in the “sentence model database”. If the sentence model database contains the input sentence, search the “keyword database” about the keywords entered by the user. Then use “sentence number” and “keyword number” as the keywords to search a standard answering sentence in the “standard answer database”. Finally display the answering sentence for the user.

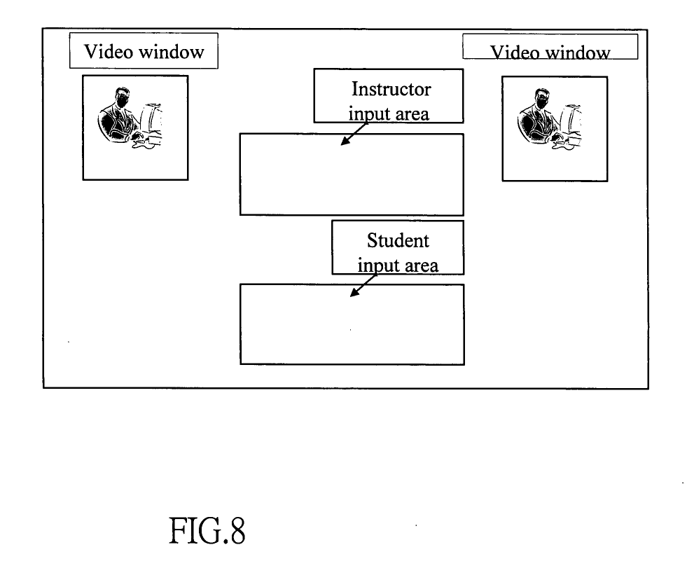

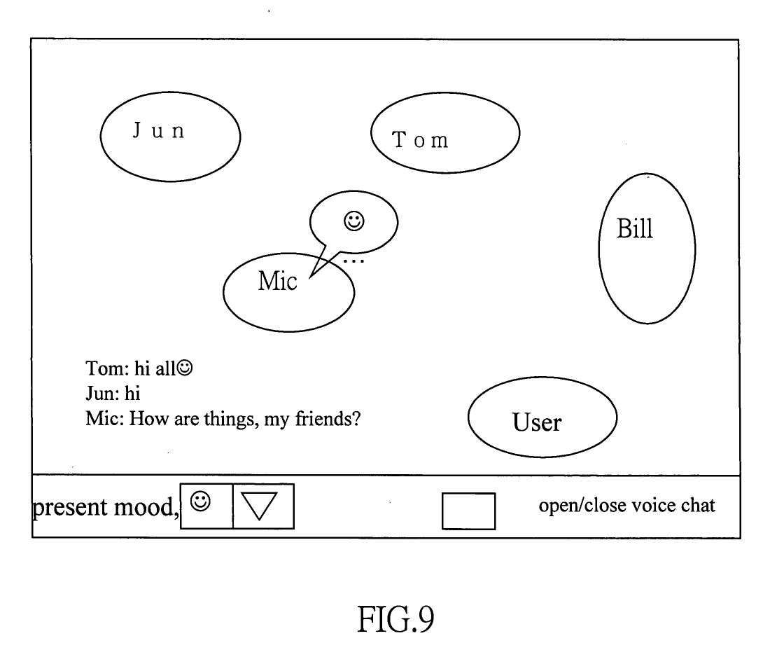

Private chat may be participated only by the people involved. It may adopt the fashion of a real people network such as establishing a link between an instructor and a student to implement data exchange through a video channel, an audio channel and keyboards. Refer to FIG. 8 for an embodiment of the interface. It also may provide communication with any users as shown in FIG. 9.

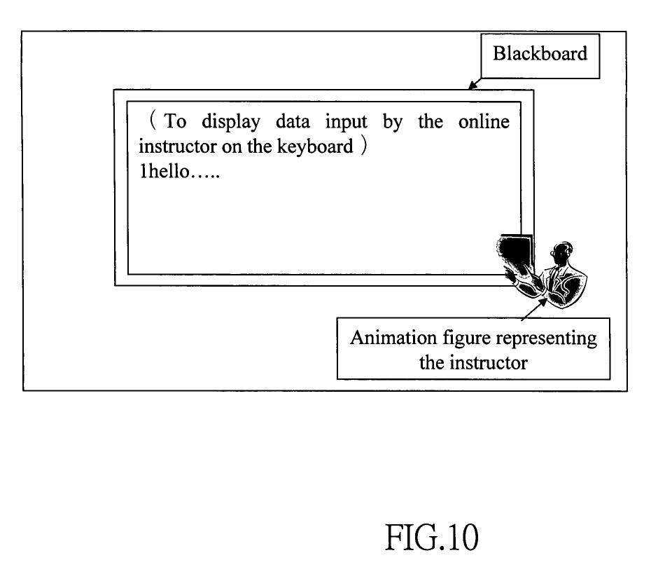

Refer to FIG. 10 for a classroom instruction interface. It is a one-to-many broadcasting mechanism for sharing information. The server end has server programs to instantly package and send the voice of an instructor and keyboard entering information to destinations of the registered user end computers, which have receiving programs. The programs at the user end can instantly restore and broadcast the packaged data.

In addition, to facilitate user communication, the invention supports setting of hot keys to enable users to designate frequently used daily phrases on keys from F1 to F12. For instance, strike F1 key can replace entering of a short sentence such as “Excuse me”.

All transactions in the community are carried out through currency. The community residents earn currency by working. And different works have different payments. The community residents can take their currencies with them or deposit in the bank. When a community resident obtained his/her ID, he/she also is given a bank account in the community bank. The resident can apply loans and pay back the loans to the community bank through the bank account, and deposit extra cashes in his/her bank account. The community government regularly deducts a certain amount of the deposit from the bank account as tax. If a resident does not have enough deposit to pay the tax and results in shortfall of the bank account, his/her moral index will be affected. The purpose is to control the behavior of the wealthy people. A resident who does not watch his/her behavior could become a beggar before long. It also aims to control currency circulation. The tax is levied according to the individual fortune. People who have a greater fortune have to pay more tax.

In order to maintain normal social order, the community also has appropriated administrative institutions, mainly including police, court, prison, news agency, etc. Initially, the network administrators take the police function. They can punish the community residents who do not observe the rules (such as put them into the prison). If there are disputes between the communities residents, they can submit their case to court for judgement. The community resident who is guilty will be punished or even put in prison. The community has its own law, which will be gradually refined with the continuous development of the community. The news agency is responsible for publishing the information of the community. The community citizens can access the latest news of the community by listening to the radio, reading the community newspaper or reading the announcements posted on the bulletin board in front of the “community service center”. As the community becomes well established, the community news agency system also will be gradually opened for the users.

Like a real society, living in the community also demands to buy some staples such as clothes, foods, houses and transportation. The community residents have to work, to earn the currency, in order to buy the living staples, otherwise they become beggars. The beggars cannot survive by themselves, and have to be supported by the welfare of the government (welfare distribution is directly managed by the network administration). If a person remains in this condition for a prolonged period of time, the welfare will be cut off and the role, which the person plays, will “perish”. After a user has received a selected training in the “community service center” and obtained a certificate, he/she can take a job such as doctor, reporter, etc. Besides maintaining the basic living, extra currency may be used to enhance the user's living standard, such as joining high-class clubs (with games available inside), eating in expensive restaurants, purchase an expensive villa, etc. Daily administration is handled by the network administrator. The work mainly includes maintaining the order of the community (such as ordering the users to speak English) and solving all kinds of problems (such as managing user's complaints). The network administrator may also develop selected activities to improve entertainment and amusement based on his/her talents, such as makes some people sick, or set fire on a selected site, etc.

When a user leaves the community, his/her status as a resident will be maintained in the server end and be accessed in the logon of next time. The system receives logoff information from the user end and removes the user from the server based on the logoff information. Meanwhile, the attribute data of the user are stored in the server end.

In this embodiment, each user has one set of corresponding personal attribute data stored in the server end. When some events happen that change the attributes of the role which the person is playing, the user end will send the event number and person number to the server to modify the data of that person.

Each person has four basic attributes: a physical value, a charismatic value, a moral index and a health index.

The physical value is the most important attribute of a person. The initial value is 100. Its upper limit may be increased by engaging in physical works and continuous exercise. People moving in the community have to consume a certain amount of physical value. When the physical value of a person decreases, his/her moving speed slows down and cannot do some heavy physical activities. People with a low physical value for a prolonged period of time could be perished. Eating food can replenish the physical value. Different quality of foods replenishes different physical values.

All professions in the community require a selected amount of charismatic value. The higher earning professions (such as doctors, lawyers, managers, etc.) require a higher charismatic value. The charismatic value consists of two portions: a self-charismatic value and an added charismatic value. The self-charismatic value+the added charismatic value=the current charismatic value. Wearing expensive clothes can increase the added charismatic value. The amount of deposited currency in the bank also affects the charismatic value of a person. When a person has a moral index of more than 85%, his/her self-charismatic value increases continuously. On the contrary, if a person has a moral index below 85%, his/her self charismatic value decreases continuously. Moreover, if the moral index is lower than 50%, the current charismatic value (including the added charismatic value) also decreases continuously until finally he/she cannot do any type of work.

The moral index is an important percentage. It relates to the behavior of a person. It may be increased by doing good things (such as donating money to beggars, helping other people and being praised in public, pay the bank loan timely, etc.). On the contrary, bad behavior will result in decreasing of the moral index (such as doing bad things and being accused and confirmed of wrong doing, bad credit resulting from deferred payments of the bank loan, indicted and sentenced by court because of guilt, etc.). This index aims to establish desired community orders and behavior and habits.

The health index also is a percentage number. It directly affects the physical value. If a person has a physical value at the upper limit of 100, and a health index 90%, the replenished physical value he/she can possibly achieve through all kinds of means is 100×90%=90. The health index is affected by living conditions and the like.

The people in the community have to work and earn money to buy food and other goods. Different works requires different qualifications. As previously discussed, different works also have different requirements of the charismatic value. However, these are still not all of the factors to be taken into account. For instance, a porter needs a certain physical strength, and a doctor requires a higher moral index. The attribute parameters required for a simple work may be achieved by reading operation manuals, while complex work requires a special training and has to pass the interview with the NPC evaluator and obtain a work certificate. Work content mostly matches the capacity of the person involved. Initially, many jobs (such as store clerks) in the community are taken by the NPC or the instructors. As the community grows and becomes more mature, these works will be gradually opened for the users to facilitate more comprehensive language learning.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A virtual scene interactive language learning system employing a server and a user end architecture to simulate a real language environment to provide users to learn a language in selected scenes, comprising:
a scene database for storing a plurality of scenes corresponding to selected subjects and scene elements corresponding to the scenes;
a logon module to monitor linking signals sent by the users at the used end and authenticate the legitimacy thereof, and set up the users in the server based on the legitimacy;
a schedule management module for managing schedules of the user end and confirming current conditions of the scenes through data exchange between the user end and the server end;
a scene editing module to perform cycle editing for the scene elements corresponding to the scene conditions, and present edited interfaces to the user end and receive action operation input from the user end and make corresponding responses based on the action operation;
a language exchange module to receive exchange data input by from user end and make corresponding responses at the user end based on the exchange data; and
a logoff module to receive logoff information from the user end and remove the users from the server based on the logoff information and store attribute data of the users in the server.

2. The virtual scene interactive language learning system of claim 1 further including an attribute calculation module which is linked to the scene editing module to calculate the attribute data of the users according to the responses and store the attribute data in the server end.

3. The virtual scene interactive language learning system of claim 1, wherein the scene elements include background elements, object elements, people elements and sound elements.

4. The virtual scene interactive language learning system of claim 1, wherein the language exchange module further includes:
a human machine dialog unit to receive voice data input by the users and compare the voice data with a sentence model in the server, and retrieve a corresponding answering sentence according to the comparing result and send the retrieved answering sentence to the user end for displaying; and
a user exchange unit to implement communication with online users.

5. The virtual scene interactive language learning system of claim 4, wherein the human machine dialog unit includes a keyboard to receive data input by the users and compare the data with a sentence model in the server, and retrieve a corresponding answering sentence according to the comparing result and sends the retrieved answering sentence to the user end for displaying.

6. The virtual scene interactive language learning system of claim 4, wherein the user exchange unit is an instruction unit which includes classroom instructions and individual instructions, the users at the user end being classified as instructor users and student users, and a connection being established between an online instructor user and a plurality of the student users, and information input by the online instructor user being instantly sent to the student end for displaying.

7. The virtual scene interactive language learning system of claim 1, wherein the attribute data include a physical value, a charismatic value, a moral index and a health index.

8. A virtual scene interactive language learning method employing a server and a user end architecture to simulate a real language environment to provide users to learn a language in selected scenes, comprising the steps of:
storing a plurality of scenes corresponding to selected subjects and scene elements corresponding to the scenes;
monitoring linking signals sent by the user end and authenticate legitimacy thereof, and setting up the users in the server based on the legitimacy;
managing schedules of the user end and establishing an instant communication between the user end and the server end, and confirming current conditions of the scenes through data exchange between the user end and the server end;
performing cycle editing for the scene elements corresponding to the scene conditions, and presenting edited interfaces to the user end and receiving action operation input from the user end and making corresponding responses based on the action operation;
receiving voice data input from the user end and making corresponding responses at the user end based on the voice data; and
receiving logoff information from the user end and removing the users from the server based on the logoff information and storing attribute data of the users in the server.

9. The virtual scene interactive language learning method of claim 8 further including calculating the attribute data of the users according to the responses and storing the attribute data in the server end.

10. The virtual scene interactive language learning method of claim 8, wherein the scene elements include background elements, object elements, people elements and sound elements.

11. The virtual scene interactive language learning method of claim 8, wherein the receiving voice data input from the user end and making corresponding responses at the user end based on the voice data further includes:
receiving the voice data input by the users;
comparing the voice data with a sentence model in the server end; and
retrieving a corresponding answering sentence based on the comparing result and sending the answering sentence to the user end for displaying.

12. The virtual scene interactive language learning method of claim 8, wherein the receiving voice data input by the user end and making corresponding responses at the user end based on the voice data includes sending the responses to another user end to implement an instant online communication.

13. The virtual scene interactive language learning method of claim 12, wherein the online communication is an instruction activity, which includes a classroom instruction and an individual instruction.

14. The virtual scene interactive language learning method of claim 13, wherein the instruction activity includes the steps of:
classifying the users at the user end to instructor users and student users;
establishing a link between online instructor users and online student users; and
sending instantly information entered by the online instructor users to the student user end for displaying.

15. The virtual scene interactive language learning method of claim 8, wherein the attribute data include a physical value, a charismatic value, a moral index and a health index.
